(19) United States
(12) Patent Application Publication
(10) Pub. No.: US 2011/0091266 A1
(43) Pub. Date: Apr. 21, 2011

(54) Notebook Divider

(76) Inventor: G. Randall Bell, Laguna Beach, CA (US)

(21) Appl. No.: 12/891,780

(22) Filed: Sep. 27, 2010

Related U.S. Application Data
(60) Provisional application No. 61/277,495, filed on Sep. 25, 2009.
(60) Provisional application No. 61/366,912, filed on Jul. 22, 2010.

(51) Int. Cl. B42F 13/00

(52) U.S. Cl. 402/79

(57) ABSTRACT

A notebook divider configured to insert into notebook bound pages has a generally rectangular planar inner panel having an inner panel front side and an inner panel back side and a generally rectangular planar outer panel having an outer panel front side and an outer panel back side. A hinge rotatably connects the outer panel to the inner panel so that the outer panel can be moved between a folded position generally overlapping the inner panel and an unfolded position generally juxtaposed with the inner panel.

### CROSS-REFERENCE TO RELATED APPLICATIONS

The present application claims priority benefit under 35 U.S.C. §119(e) to U.S. Provisional Patent Application Ser. No. 61/277,495, filed Sep. 25, 2009, titled Strategic Planning Method and U.S. Provisional Patent Application Ser. No. 61/366,912, filed Jul. 22, 2010, titled Strategic Planner, all of the above-referenced applications hereby incorporated by reference herein.

### INCORPORATION BY REFERENCE OF COPENDING RELATED APPLICATION

The present application is related to U.S. Utility patent application Ser. No. 12/______, filed Sep. 27, 2010, titled Strategic Planner, incorporated by reference herein.

### BACKGROUND OF THE INVENTION

Strategic planning is an important activity for both business and personal endeavors. Strategic planning typically includes devising goals and strategies and setting objectives and tasks. Goals specify accomplishments needed to achieve an overall result, such as the stated mission of an organization. Strategies are the methods or processes required to achieve those goals. Objectives provide specific milestones toward achieving goals. Tasks are those activities designed to meet each milestone according to the identified strategies. Part of strategic planning is also the regular evaluation of the planning process and its implementation so as to assess whether goals are being achieved and determine whether the plan should be modified or updated.

### SUMMARY OF THE INVENTION

A strategic planner advantageously integrates all of the elements needed for both business and personal planning including a notebook binder, a roadmap, a planning section, a multi-purpose notebook divider and calendar pages. The roadmap defines a methodology for developing goals and strategies according to multiple categories. These categories define the conceptual framework of the strategic planner. The planning section provides sheets organized by tabbed dividers, which define subsections corresponding to the roadmap categories. Each subsection allows the user to write out specific goals and strategies according to the tabbed category and to derive objectives accordingly. The notebook divider is typically positioned at the current date within the calendar pages. The divider provides areas labeled according to the roadmap categories. One use for these areas is to temporarily record objectives derived and recorded in the tabbed planning section. When objectives are met or modified, new objectives can be recorded. The divider and its specified objectives can then be used to derive detailed tasks written on the calendar pages. In an embodiment, a portion of the divider can be used to record the success or failure of tasks and corresponding objectives, which can be used as feedback to the planning subsections to modify goals and strategies accordingly.

One aspect of a notebook divider configured to insert into notebook bound pages comprises a generally rectangular planar inner panel having an inner panel front side and an inner panel back side and a generally rectangular planar outer panel having an outer panel front side and an outer panel back side. A hinge rotatably connects the outer panel to the inner panel so that the outer panel can be moved between a folded position generally overlapping the inner panel and an unfolded position generally juxtaposed with the inner panel. In various embodiments, the notebook divider has a holed edge of the inner panel defining a plurality of notebook apertures for attaching the inner panel onto notebook binders. The inner panel and outer panel are movable in the folded position along notebook binders between a front-side position and a back-side position. An inner hinge edge of the inner panel is opposite the holed edge and the inner hinge edge defines inner hinge notches and adjacent inner hinge inserts. An outer hinge edge of the outer panel defines outer hinge notches and adjacent outer hinge inserts. The hinge comprises the inner hinge inserts and notches interleaved with the outer hinge inserts and notches. The inner hinge inserts each have a relatively narrow neck extending from the inner hinge edge and a relatively wide head extending from the neck. The neck inserts into an outer hinge notch so that the head is captured by the outer hinge notch.

Another aspect of a notebook divider is a method comprising providing an inner panel and an outer panel and folding the inner panel onto the outer panel so as to temporarily hide at least a portion of the inner panel and outer panel front sides. In various embodiments, folding comprises interleaving a serrated inner panel edge and a serrated outer panel edge to form a hinge and rotating the inner panel about the outer panel. Interleaving comprises defining inserts and corresponding notches along the serrated edges of the inner and outer panels and interlocking the serrated edges so as to maintain the integrity of the hinge. Interlocking comprises configuring the inserts with relatively wide insert heads and relatively narrow insert necks, configuring the notches with relatively wide notch heads and relatively narrow notch necks and interleaving inserts on one of the inner and outer panels with notches on the other of the outer and inner panels so that the insert heads are captured by the notch heads.

A further aspect of a notebook divider comprises an inner panel, an outer panel and a hinge means for interconnecting the inner panel and outer panel so that the inner panel rotates about the outer panel. In various embodiments, the hinge means comprises an inner panel serrated edge means for defining an inner panel hinge portion, an outer panel serrated edge means for defining an outer panel hinge portion. The inner panel serrated edge means and the outer panel serrated edge means are interlocked. The inner panel serrated edge means has inner panel insert means for defining corresponding inner panel notch means. The outer panel serrated edge means has outer panel insert means for defining corresponding outer panel notch means. The inner panel insert means interleaves with the outer panel notch means, and the outer panel insert means interleaves with the inner panel notch means. The inner panel insert means inserts into the outer panel notch means and the outer panel insert means inserts into the inner panel notch means.

One aspect of a strategic planner comprises a roadmap, a tabbed planning section, first tabbed dividers, second tabbed dividers, a calendar section and a notebook divider. The roadmap has a planning matrix of rows and columns displayed according to planning categories and planning concepts. The tabbed planning section has planning pages. The first tabbed dividers interleaved with the planning pages and are labeled according to the planning categories. The calendar section has calendar pages interleaved with the second tabbed dividers, which are labeled according to months of the year. The notebook divider is located within the calendar pages according to the current month and the current day of the week and displays cells listing the planning concepts. The cells are organized according to the planning categories and have blank areas for recording planning objectives derived from the planning concepts and planning categories.

In various embodiments, icons identify the roadmap planning categories and the notebook divider cells. The notebook divider is foldable and movable between an open position, a closed front-side position and a closed back-side position. The open position displays the cells, the closed front-side position displays the categories and concepts and the closed back-side position displays the categories and has blank areas corresponding to the categories. The notebook divider has an inner panel, an outer panel and a hinge that rotatably connects the inner panel and the outer panel so that the notebook divider is foldable. The inner panel comprises a front side, a reverse side, holed edge and a hinge edge opposite the holed edge. The inner panel front side displays the categories and the concepts and the reverse side displays the categories and the blank areas. The outer panel has a front side, a reverse side and a hinge edge. The hinge edges of the inner and outer panels are interleaved so as to form the hinge. The outer panel front side displays cells listing examples of planning concepts according to the categories. The outer panel reverse side displays the categories and the concepts.

Another aspect of a strategic planner is a strategic planning roadmap describing planning concepts according to planning categories. A planning section has pages divided into planning subsections and tabbed according to the planning categories. The planning concepts are referenced in the roadmap so as to develop goals and strategies for achieving those goals. The goals and strategies are recorded in the planning subsections under the corresponding tabbed categories. The planning subsections are referenced so as to develop objectives for achieving the recorded goals according to the recorded strategies. A notebook divider has spaces labeled according to the planning categories where the objectives are recorded. A calendar section has pages labeled according to months and days, and the notebook divider is generally located within a current date portion of the calendar section. Daily tasks are recorded within the current date portion of the calendar section according to the objectives listed on the notebook divider.

In various embodiments a strategic planning roadmap displays a matrix of planning categories and planning principles. The notebook divider has an inner panel, an outer panel and a hinge attaching the panels so as to fold the notebook divider between the panels. The notebook divider is moved between an open position and a closed position via the hinge. Binder apertures are located along a holed edge of the inner panel for securing the notebook divider to a binder and moving the notebook divider between a closed front-side position and a closed back-side position. Planning categories and planning concepts are displayed on the notebook divider in the closed front-side position. Planning categories and blank areas on the notebook divider are displayed on the notebook divider in the closed back-side position. Objectives are recorded in the blank areas according to the planning categories.

A further aspect of a strategic planner is a roadmap means for defining a strategic plan according to planning categories and planning principles listed in a roadmap matrix. A tabbed planning section means is for recording goals and strategies for the strategic plan according to the planning categories. A notebook divider means is for recording objectives based upon the recorded goals and strategies. The notebook divider means is placed at a current date within a calendar pages section. An icon means is for pictorially identifying the planning categories. The icon means is displayed on the roadmap matrix and the notebook divider. A cell means is displayed on the notebook divider for recording objectives. A hinge means is for selectively displaying portions of an inner panel and an outer panel of the notebook divider. A removable label means is for placing written objectives in the cell means. An erasable pen means is for writing objectives in the cell means.

### BRIEF DESCRIPTION OF THE DRAWINGS

FIG. 1 is a block diagram of a strategic planner;

FIG. 2 is a perspective view of a strategic planner embodiment;

FIG. 3 is a detailed illustration of a notebook-size roadmap embodiment;

FIGS. 4A-B are detailed illustrations of a pocket-size roadmap embodiment;

FIGS. 5A-D are detailed illustrations of a notebook divider embodiment having open front, partially-folded front, folded front and folded back positions;

FIG. 6 is a general flow diagram of a strategic planning process;

FIGS. 7A-B are front and back views, respectively, of a 8.5″×11″ notebook divider inner panel embodiment;

FIGS. 8A-B front and back views, respectively, of a 8.5″×11″ notebook divider outer panel embodiment;

FIGS. 9A-B are front and back views, respectively, of a 5.5″×8.5″ notebook divider inner panel embodiment; and

FIGS. 10A-B are front and back views, respectively, of a 5.5″×8.5″ notebook divider outer panel embodiment.

### DETAILED DESCRIPTION OF THE PREFERRED EMBODIMENTS

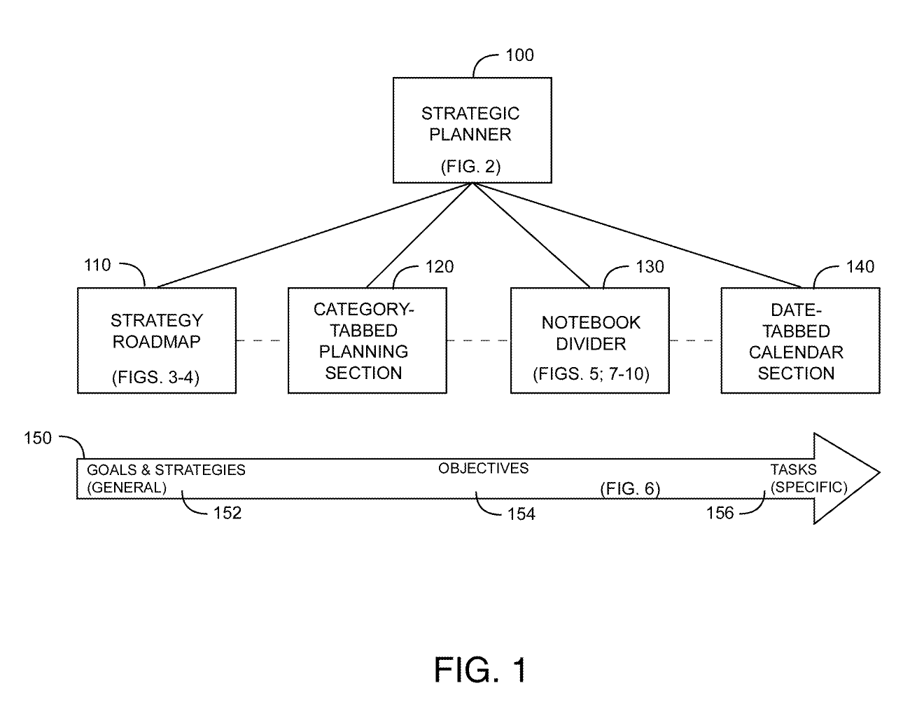

FIG. 1 functionally illustrates a strategic planner 100 and corresponding strategic planning process 150. In an embodiment, the strategic planner 100 has a strategy roadmap 110, a category-tabbed planning section 120, a notebook divider 130 and a date-tabbed calendar section 140. A corresponding strategic planning method 150 advantageously uses the strategic planner 100 to develop and refine a business or personal plan from general goals and strategies 152 recorded in the categorized planning section 120 according to the roadmap 110 to narrower objectives 154 recorded on the notebook divider 130 based on the planning section 120 and finally to specific tasks 156 set forth in the calendar section 140.

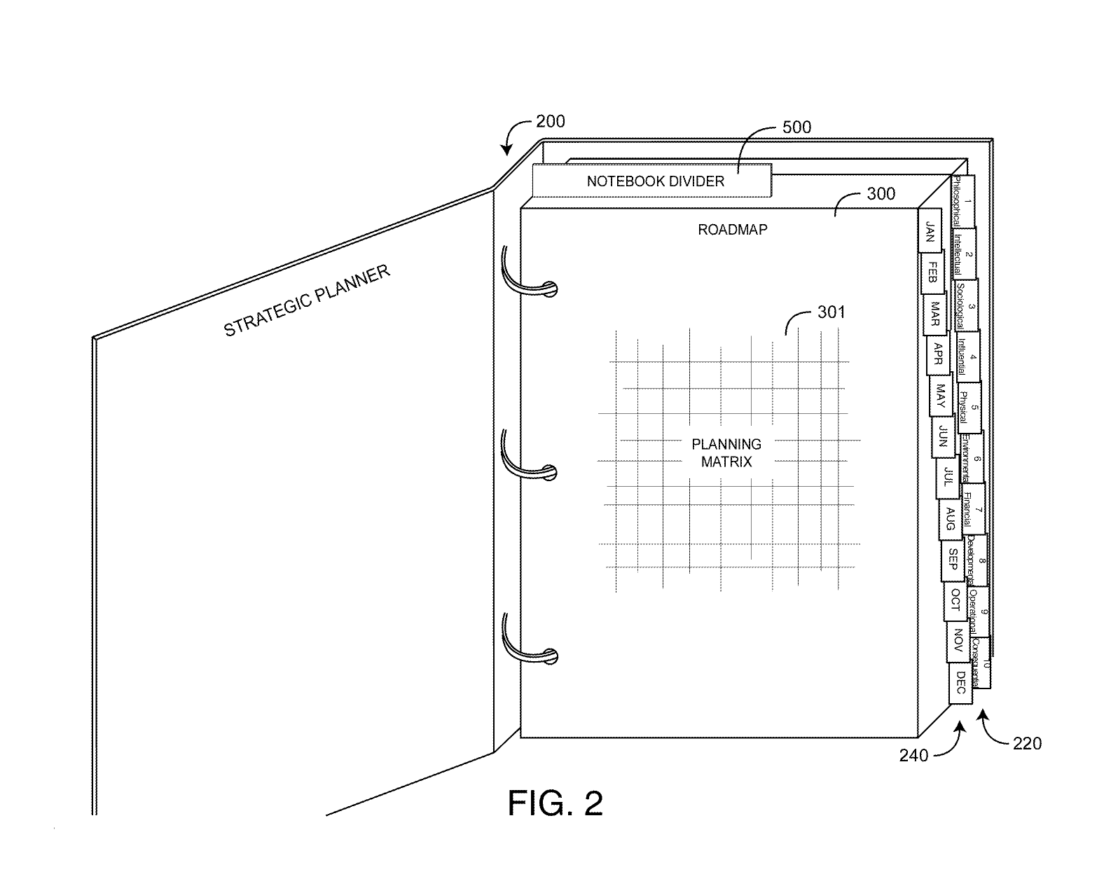

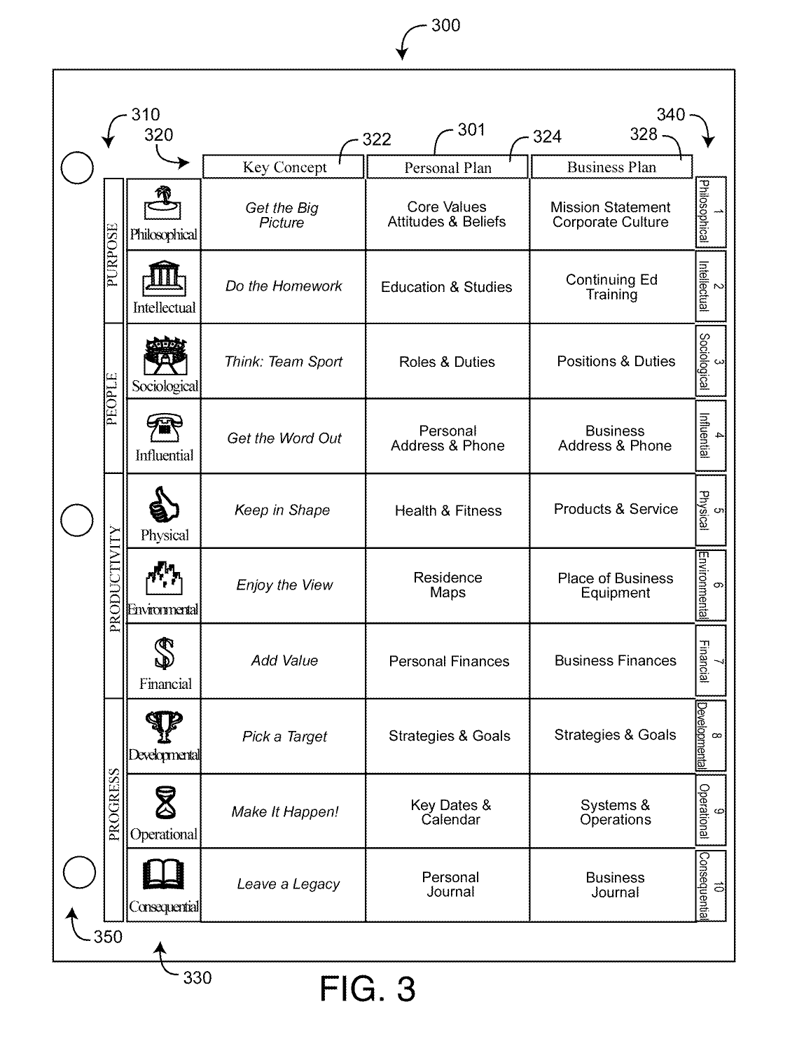

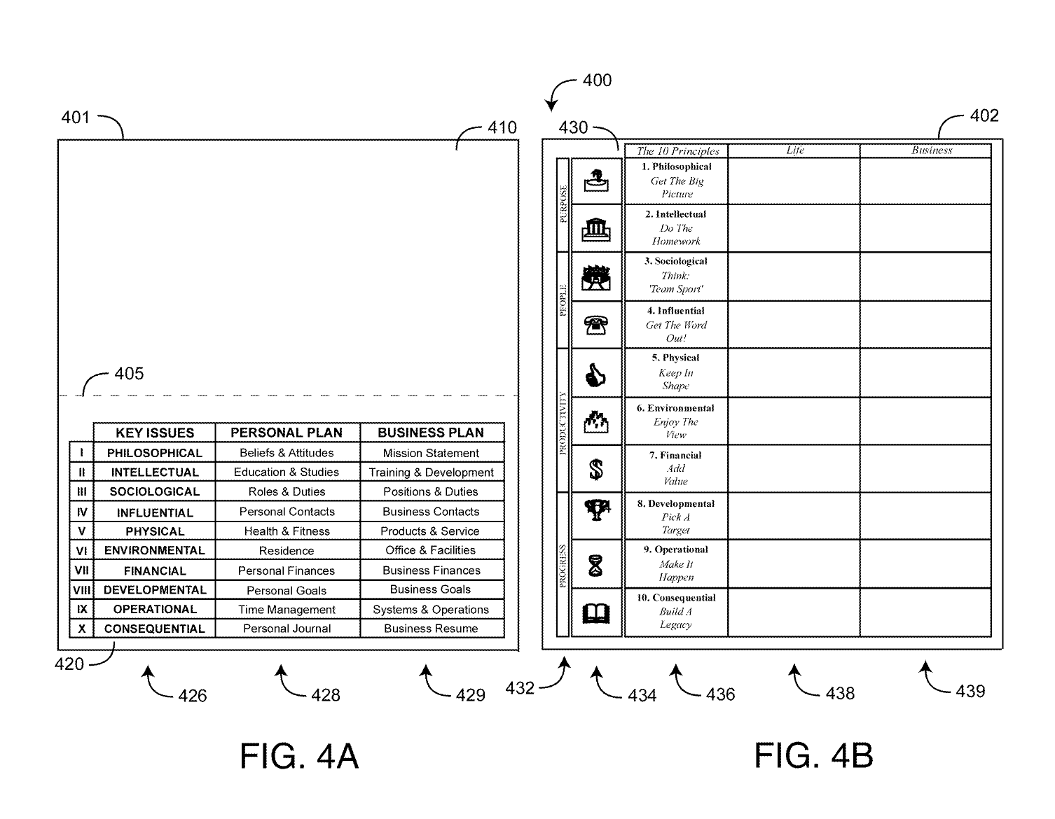

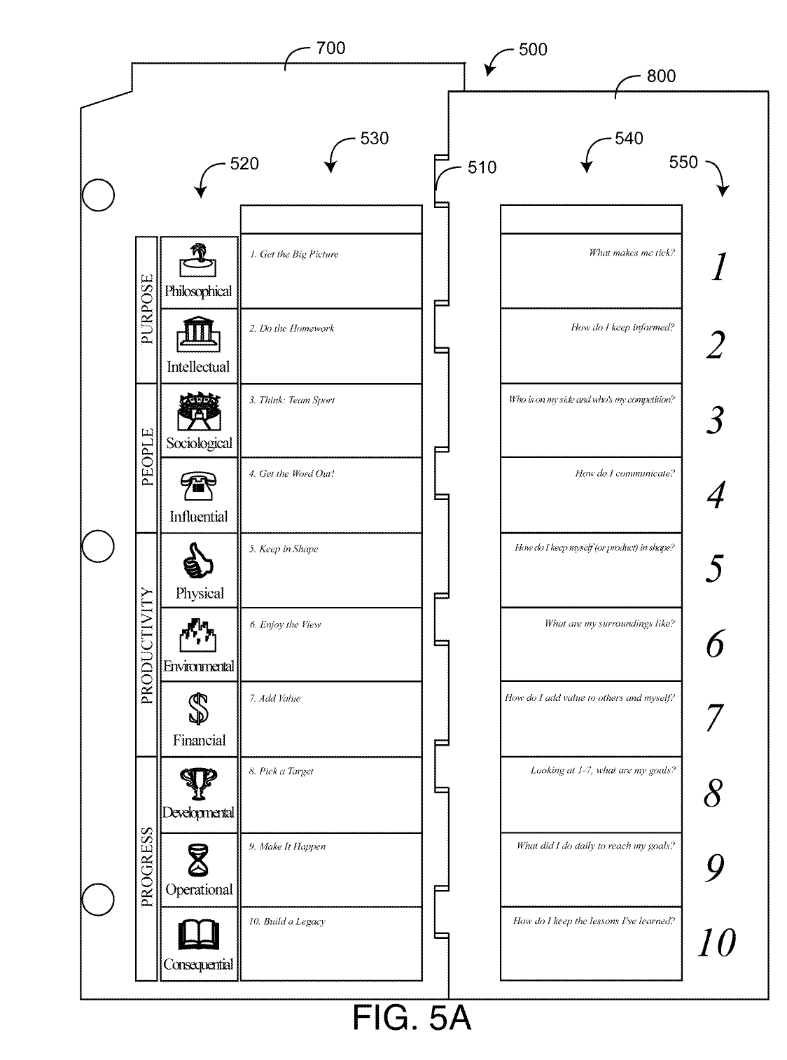

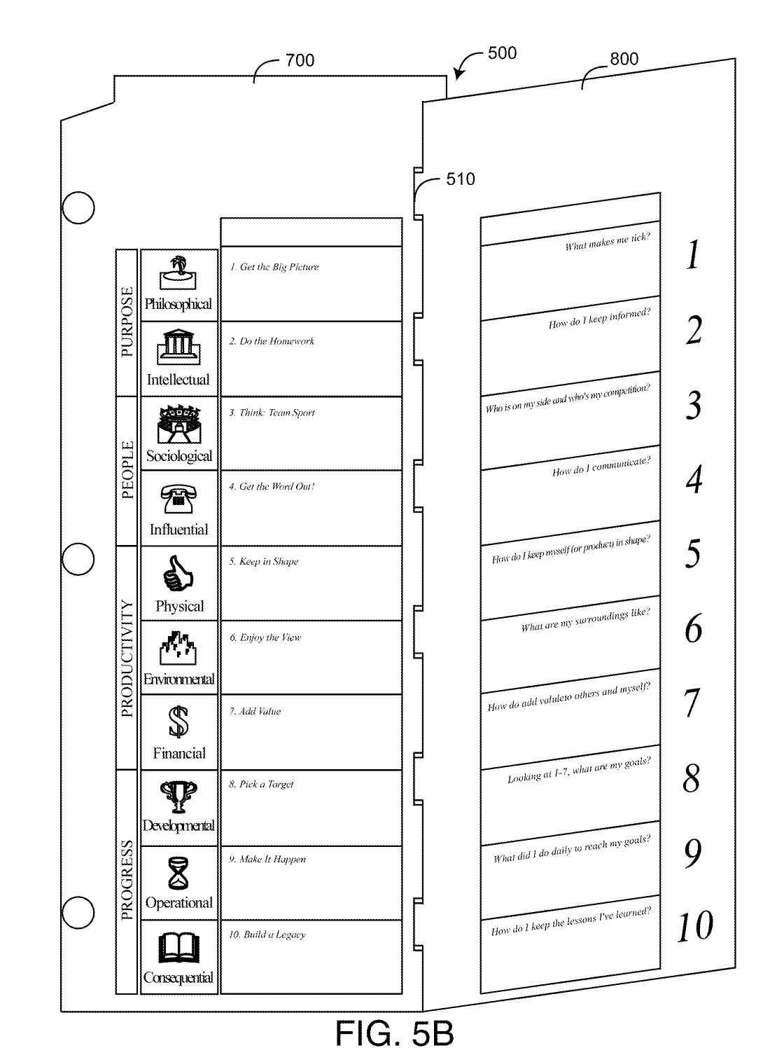

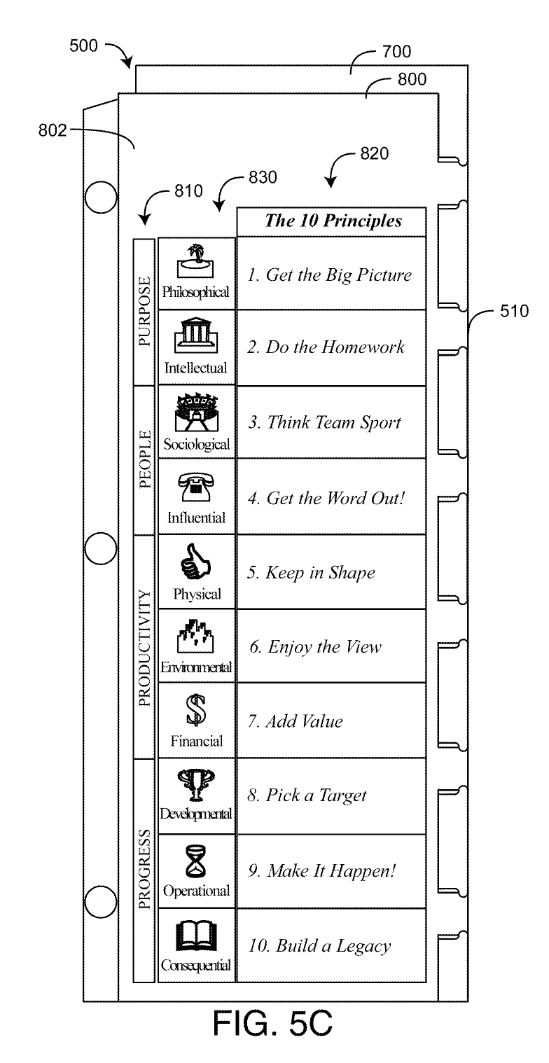

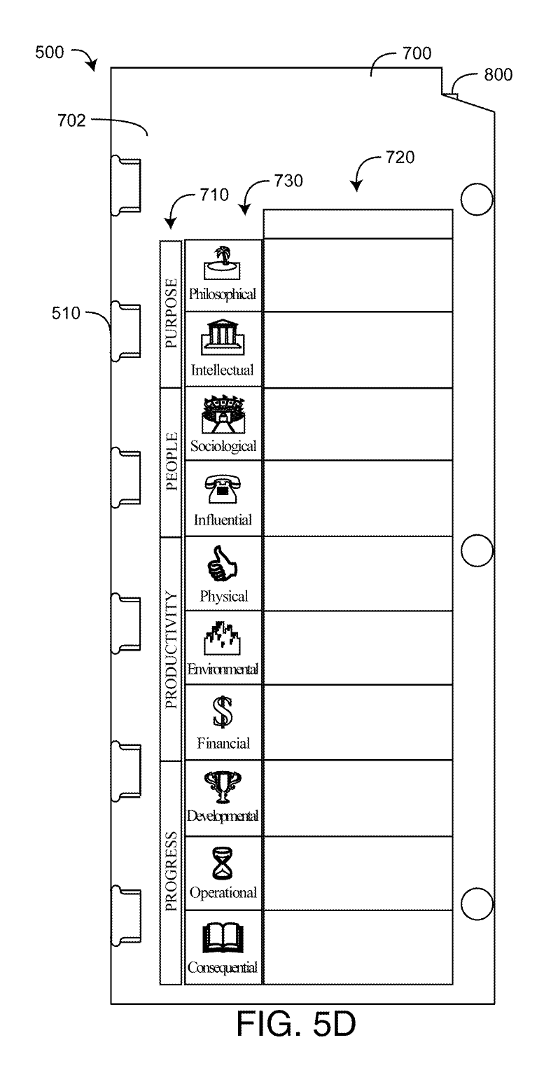

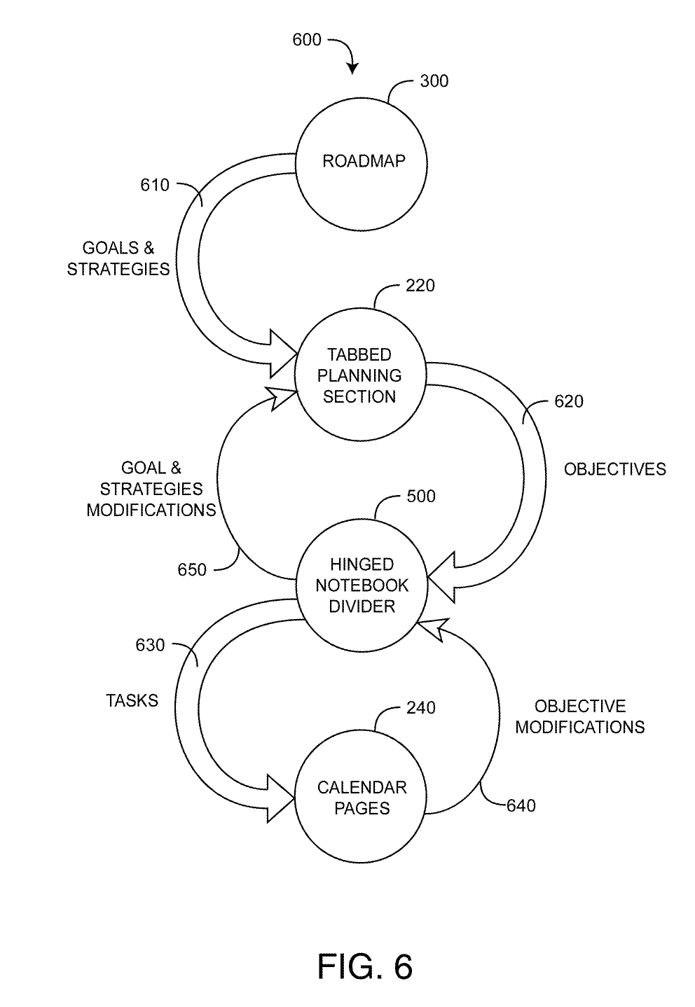

A strategic planner embodiment is described with respect to FIG. 2, below. Strategy roadmap 110 embodiments are described in further detail with respect to FIGS. 3-4, below. A categorized planning section 120 having tabs labeled according to roadmap categories is described with respect to FIG. 2, below. Notebook divider 130 embodiments are described with respect to FIGS. 5 and 7-10, below. A date-tabbed calendar section 140 is shown in FIG. 2, below, and can be any of a variety of commercially-available preprinted calendar pages listing the day, week and/or month for a specific year and, likewise, tabbed according to month, as shown. A strategic planning method 150 is described in further detail with respect to FIG. 6, below.

FIG. 2 illustrates a strategic planner 200 having a roadmap 300 with a planning matrix 301, a tabbed planning section 220, a calendar pages section 240 and a notebook divider 500. Advantageously, a strategic planner 200 assists a user in constructing a strategic plan by category according to principles referenced on the roadmap 300. Long term planning developed in the tabbed planning section 220 is translated to short term planning recorded on the notebook divider 500, such as daily or weekly goals and objectives. The notebook divider 500 is referenced in generating task lists and setting priorities for completing tasks, which are written in the calendar section 240. A planning method based upon the strategic planner is described in further detail with respect to FIG. 6, below.

FIG. 3 illustrates a roadmap 300 that organizes a planning matrix 301 according to general categories 310 in rows and concepts 320 in columns. In an embodiment, the general categories include Purpose, People, Productivity, and Progress. In an embodiment, the general categories breakdown into more specific subcategories 330 that tie into the planning section tabs 220 (FIG. 2). In particular, the Purpose category includes Philosophical and Intellectual subcategories corresponding to tabs 1 and 2. The People category has Sociological and Influential subcategories corresponding to tabs 3 and 4. The Productivity category has Physical, Environmental, and Financial subcategories corresponding tabs 5, 6 and 7. The Progress category has Developmental, Operational, and Consequential subcategories corresponding to tabs 8, 9 and 10. The roadmap 300 also has tab references 340 corresponding to the planning section tabs 220 (FIG. 2). In an embodiment, the subcategories 330 include readily recognizable mnemonic icons. In an embodiment the concepts 320 include a key concept 322, a personal plan 324 and a business plan 328. In other embodiments, plan categories 310, 330 may have various types of divisions and subdivisions besides or in addition to those described above.

As shown in FIG. 3, the planning matrix 301 contains cells corresponding to each subcategory and each concept/plan type. In an embodiment, Philosophical cells include Get the Big Picture; Core Values—Attitudes and Beliefs and Mission Statement—Corporate Culture. Intellectual cells include Do the Homework; Education and Studies and Continuing Education Training. Sociological cells include Think: Team Sport; Roles and Duties and Positions and Duties. Influential cells include Get the Word Out; Personal Address and Phone and Business Address and Phone. Physical cells include Keep in Shape; Health and Fitness, and Products and Services. Environmental cells include Enjoy the View; Residence Maps and Place of Business Equipment. Financial cells include Add Value; Personal Finances and Business Finances. Developmental cells include Pick a Target and Strategies and Goals. Operational cells include Make It Happen; Key Dates and Calendar and Systems and Operations. Consequential cells include Leave a Legacy; Personal Journal and Business Journal.

FIGS. 4A-B illustrate a 3.5″×4.0″ pocket planner 400 embodiment that folds along a fold line 405 to a standard 3.5″×2.0″ business card size. The pocket planner 400 serves as an abbreviated planning roadmap, somewhat comparable to the full-sized roadmap 300 (FIG. 3), described above. In an embodiment, the pocket planner 400 has an outside 401 and an inside 402 (when folded). As shown in FIG. 4A, the outside 401 has an undedicated section 410 that can be printed with a variety of information ranging from business card data to advertising, as examples. The outside 401 also has a dedicated section 420, which in an embodiment is printed with a definitional matrix having subcategories 426, such as described with respect to the roadmap 300 (FIG. 3), above. Personal plan cells 428 and business plan cells 429 have preprinted definitions corresponding to the subcategories 426.

As shown in FIG. 4B, the inside 402 has an abbreviated planning matrix 430 having categories 432, subcategory icons 434 and subcategory titles and corresponding concepts 436, as described with respect to the planning roadmap 300 (FIG. 3), above. Further, the abbreviated planning matrix 430 has blank cells for writing or otherwise recording specific goals, strategies and objectives, as described herein.

FIGS. 5A-D illustrate a notebook divider embodiment 500 having an inner panel 700 that attaches to the notebook binder rings and an outer panel 800 that attaches to the inner panel 700. A hinge 510 rotatably connects the panels 700, 800 so that the notebook divider 500 can be folded between an open position FIG. 5A, a partially closed position FIG. 5B and a closed front-side position FIG. 5C. Further, in the closed position FIG. 5C, the divider can be flipped on the notebook binder rings between a front side FIG. 5C and a back-side FIG. 5D. In this manner, the divider can be used with complete flexibility for the purposes described with respect to FIGS. 1-3, above. In an embodiment, the notebook divider 500 is sized for an 8.5″×11″ notebook.

As shown in FIG. 5A, in an open position the notebook divider roughly corresponds to the layout of the roadmap 300 (FIG. 3). In particular, general categories, subcategories and corresponding icons 520 are displayed on the left side and corresponding tab numbers 550 are displayed on the right side. Further, concept cells 530 are displayed next to the categories and subcategories 520. In an embodiment, the concept cells 530 may include labels listing the key concepts and blank areas for recording objectives related to the key concepts, as described above. Adjacent the tab numbers 550 are personal cells 540. In an embodiment, the personal cells 540 may be preprinted with personal planning questions. In an embodiment, the key concepts include Get the Big Picture; Do the Homework; Think: Team Sport; Get the Word Out; Keep in Shape; Enjoy the View; Add Value; Pick a Target; Make It Happen; and Leave a Legacy. In an embodiment, the personal planning questions include What makes me tick?; How do I keep informed?; Who is on my side and who's my competition?; How do I communicate?; How do I keep myself (or product) in shape?; What are my surroundings like?; How do I add value to others and myself?; Looking at 1-7, what are my goals?; What did I do daily to reach my goals? and How do I keep the lessons I've learned?

In an embodiment, the cells 530, 540 have blank areas for writing or otherwise recording objectives. In various embodiments, these blank areas may be recorded with one or more of an erasable pen or pencil, individual removable paper labels corresponding in size to each cell or removable paper strips corresponding in size to an entire column of cells, to name a few. The paper labels or strips may be preprinted with the key concepts or personal planning questions described above and/or written on by hand with pen, pencil or other writing implements.

As shown in FIG. 5C, in a closed front-side position, the outer panel 800 is completely folded over onto the inner panel 700, exposing the outer panel reverse side. On the reverse side, the outer panel 800 advantageously reproduces the roadmap 300 (FIG. 3) general categories 810, subcategories 830 and key concepts 820 or principles.

As shown in FIG. 5D, in a closed back-side position, the inner panel 700 is completely folded over onto the outer panel 800, exposing the inner panel reverse side. On the reverse side, the inner panel 700 advantageously reproduces the roadmap 300 (FIG. 3) general categories 710 and subcategories 730 and also provides blank areas 720 where planning objectives can be recorded corresponding to the roadmap 300 (FIG. 3) key concepts or principles. These blank areas 720 may be recorded with one or more of an erasable pen or pencil, individual removable paper labels corresponding in size to each blank area or removable paper strips corresponding in size to an entire column of blank area, to name a few. The paper labels or strips may be preprinted with the key concepts or personal planning questions described above and/or written on by hand with pen, pencil or other writing implements.

FIG. 6 illustrates an organizational process 600 for using the strategic planner 200 (FIG. 2). Advantageously, the roadmap 300 provides an organized structure for deriving goals and strategies 610. In particular, the roadmap 300 lists planning principles according to categories and relates these categories to tabs in the planning section 220. The roadmap 300 is described in detail with respect to FIG. 3, above.

Also shown in FIG. 6, the tabbed planning section 220 advantageously provides various pages to record, modify and organize a strategic plan according to the roadmap categories. The tabbed planning section 220 also allows a quick and easy lookup and reference to the strategic plan according to these categories, which are printed on the tabs.

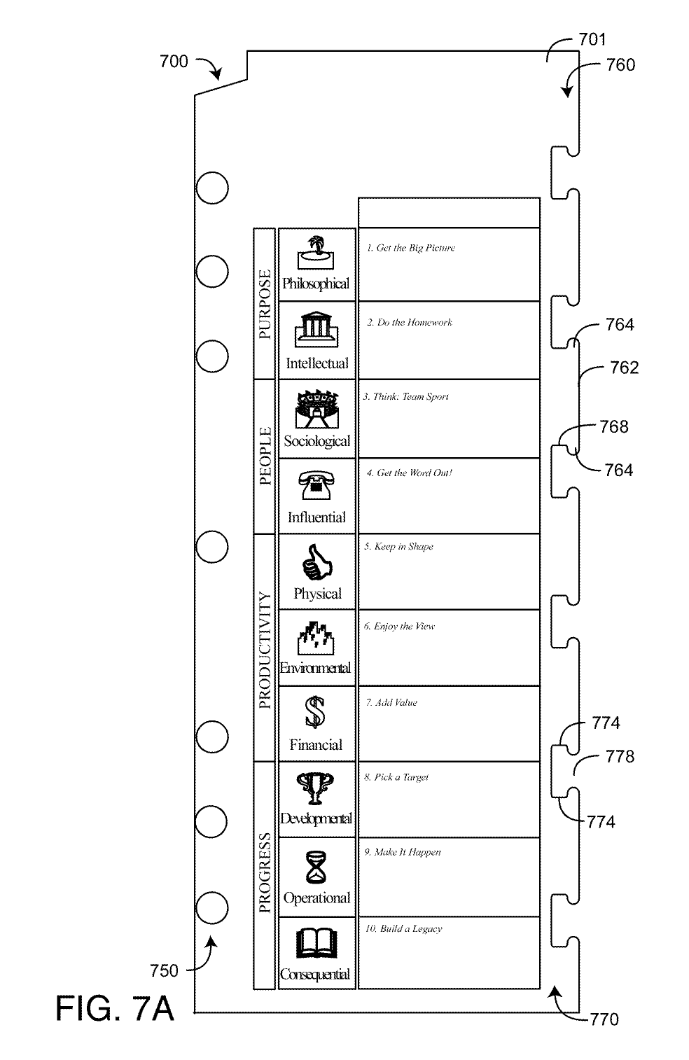

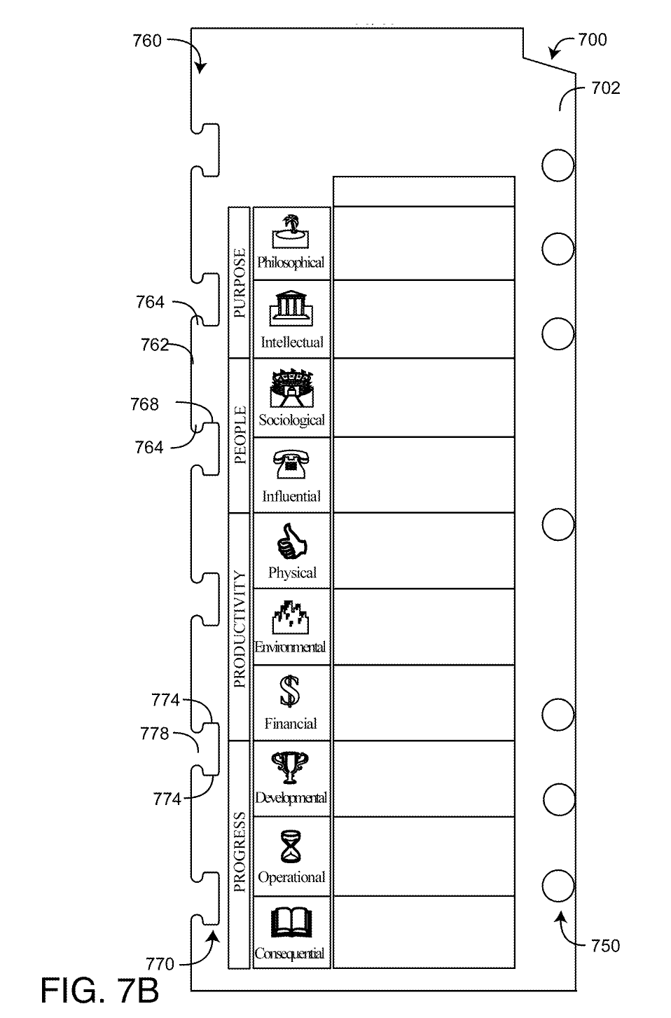

Further shown in FIG. 6, the hinged notebook divider 500 locates daily or monthly pages in the calendar section 240. In addition, the notebook divider 500 advantageously functions as a short term planner. In particular, goals and strategies 610 developed in the planning section 220 can be translated to specific objectives 620 recorded on the divider 500. As such, these objectives 620 can be easily referenced and translated to daily tasks 630 written in the calendar pages 240. The divider 500 may also be used to record objective modifications 640 gleaned from the calendar pages 240, which functions as feedback from the performance of daily activities. Similarly, goals and strategies recorded in the tabbed planning section 220 may be reviewed and modified 650 according to notes made on the notebook divider 500, described in detail with respect to FIGS. 5A-D, above, and further with respect to FIGS. 7-10, below.

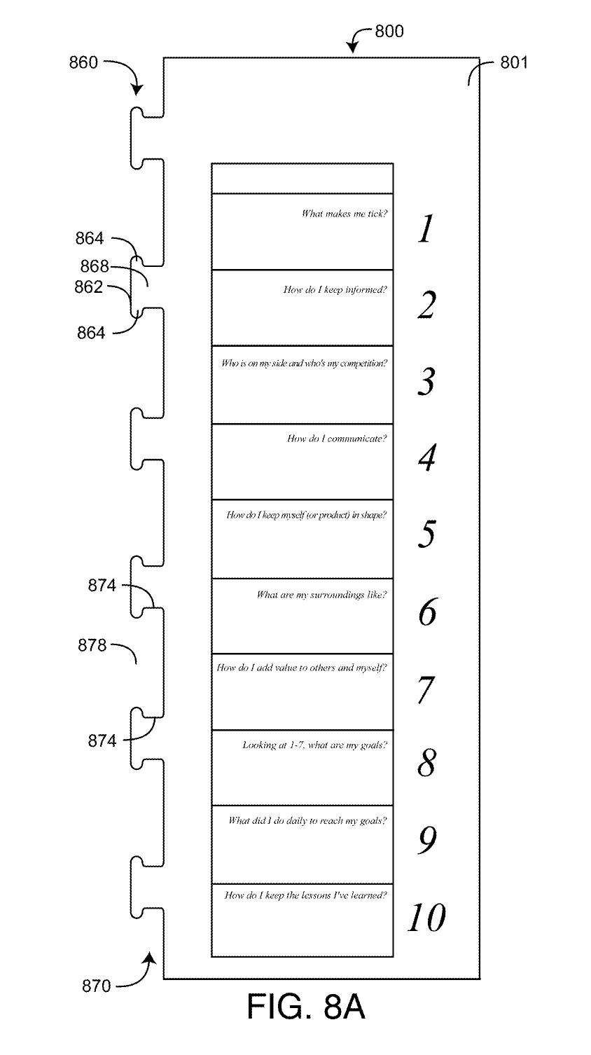

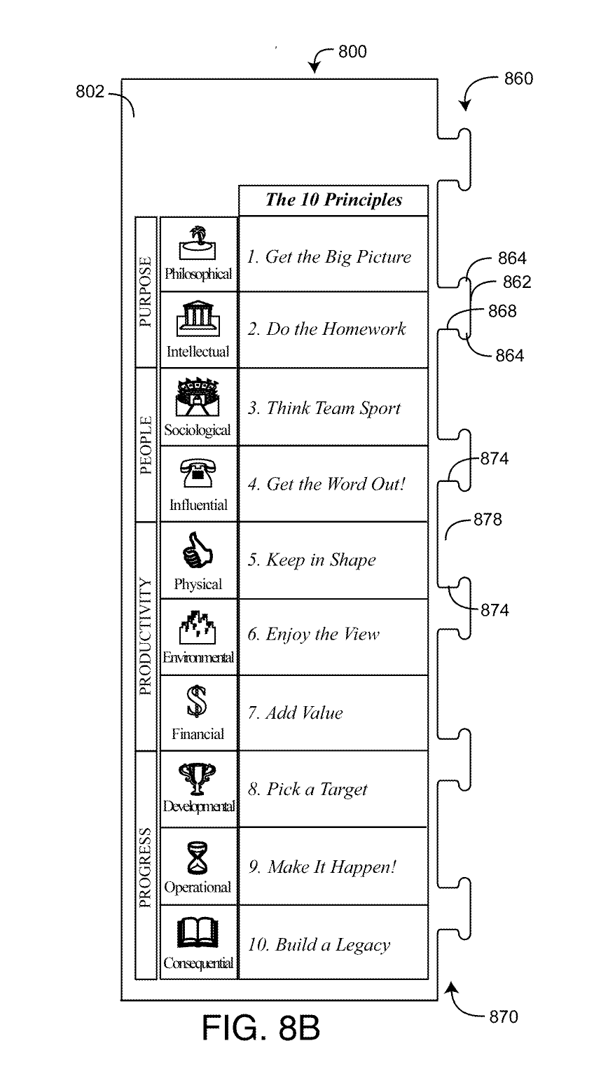

FIGS. 7-8 illustrate a divider inner panel 700 (FIGS. 7A-B) and outer panel 800 (FIGS. 8A-B) embodiment having a front side 701 (FIG. 7A), 801 (FIG. 8A) and a reverse side 702 (FIG. 7B), 802 (FIG. 8B). The inner panel 700 is a generally elongated, rectangular sheet having a protruding top, which extends from the pages of a strategic planner 200 (FIG. 2) to function as a page divider, as shown and described with respect to FIGS. 1-2, above. The inner panel 700 has a holed edge 750 and an opposite hinge edge 760, 770. The holed edge 750 has multiple apertures, which may closed, as shown, or partially open so as to allow the divider to be inserted into the planner without opening the planner rings. The outer panel 800 is a generally elongated, rectangular sheet that is somewhat smaller than the first sheet in both dimensions so that the outer panel 800 does not cover the holed edge 750 or the protruding top in the folded position (FIGS. 5C-D). The outer panel 800 has a straight edge and an opposite hinge edge 860, 870.

Advantageously, the hinge edge 760, 770 of the inner panel and the hinge edge 860, 870 of the outer panel are configured to mesh so as to form a hinge 510 (FIGS. 5A-C). The inner panel hinge edge is serrated with multiple protruding inserts 760 defining multiple notches 770. The outer panel hinge edge is also serrated with multiple protruding inserts 860 defining multiple notches 870. The inner panel inserts 760 are sized to mesh with the outer panel notches 870, and the outer panel inserts 860 are configured to mesh with the inner panel notches 770.

As shown in FIGS. 7A-B, each inner panel insert 760 has a body having a relatively wide head 762 and a relatively narrow neck 768. Except for the top and bottom inserts, each insert 760 has a pair of opposite facing ears 764 extending from the head 762. The top and bottom inserts 760 have only one ear 764 extending away from the top edge and bottom edge of the panel 700, respectively. Each inner panel notch 770 defines a relatively wide head 774 and a relatively narrow neck 778.

As shown in FIGS. 8A-B, each outer panel insert 860 has a body having a relatively wide head 862 and a relatively narrow neck 868. Each insert 860 has a pair of opposite facing ears 864 extending from the head 862. Each outer panel notch 870 defines a relatively wide head 874 and a relatively narrow neck 878. The top and bottom notches terminate along the top and bottom edges of the outer panel 800, respectively.

As shown in FIGS. 7-8, the hinge edges 760, 770 (FIGS. 7A-B) and 860, 870 (FIGS. 8A-B) mesh so as to form a hinge 510 (FIGS. 5A-D). In particular, the insert ears 764 of the inner panel 700 are wider than the notch heads 874 of the outer panel 800 so that the ears 764 are captured behind the heads 874. Similarly, the insert ears 864 of the outer panel 800 are wider than the notch heads 774 of the inner panel 700 so that the ears 864 are captured behind the heads 774. Also, the panel ears 764, 864 interlock so as to hold the hinge 510 (FIGS. 5A-D) in place. The panels 700, 800 are constructed of sufficiently stiff material so that the hinge, once meshed, remains meshed during normal operation of folding and unfolding the panels. Further, the panels 700, 800 are constructed of sufficiently flexible material so that the panels, if so intended, can be easily separated or meshed together. Hence, the hinge 510 (FIGS. 5A-D) is advantageously configured and constructed so as be easy to manufacture and from individual panels, providing a flat surface that is easy to print. Also, the hinge 510 (FIGS. 5A-D) is advantageously easy to assemble from the individual panels and yet retain the hinge integrity during use.

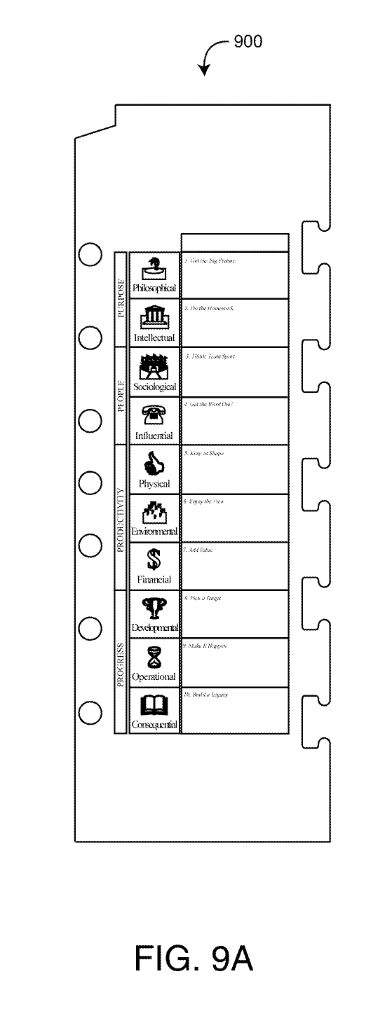

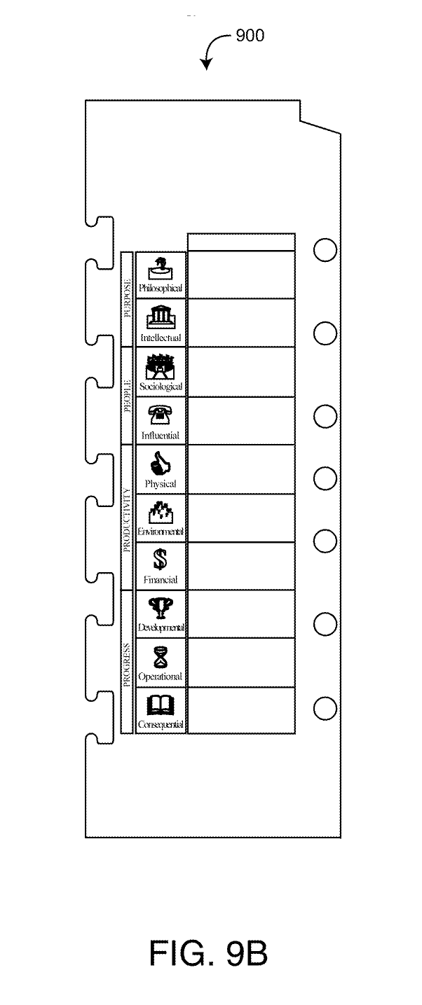

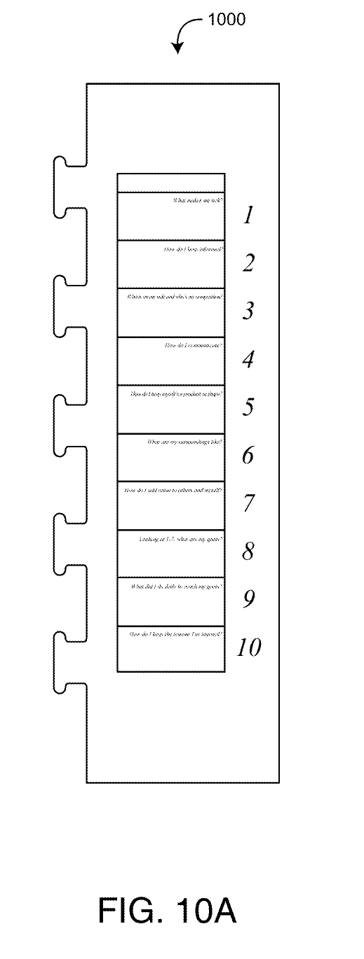

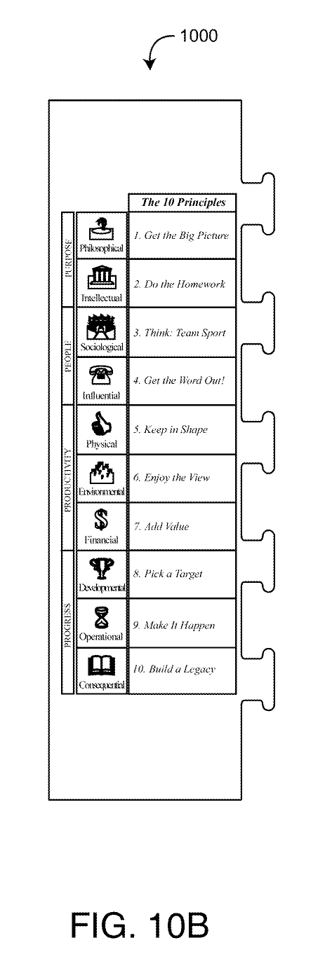

FIGS. 9-10 illustrate another notebook divider embodiment having an inner panel 900 (FIGS. 9A-B) and a outer panel 1000 (FIGS. 10A-B). The panels 900, 1000 attach along a serrated edge to form a hinge, as described with respect to FIGS. 5, 7-8, above. The notebook divider 900, 1000 is adapted for a (smaller) 5.5″×8.5″ notebook but is otherwise comparable to the notebook divider 500 (FIGS. 5, 7-8) described above.

A notebook divider has been disclosed in detail in connection with various embodiments. These embodiments are disclosed by way of examples only and are not to limit the scope of the claims that follow. One of ordinary skill in art will appreciate many variations and modifications.

What is claimed is:

1. A notebook divider is configured to insert into notebook bound pages, the notebook divider comprises:
a generally rectangular planar inner panel having an inner panel front side and an inner panel back side;
a generally rectangular planar outer panel having an outer panel front side and an outer panel back side; and
a hinge rotatably connecting the outer panel to the inner panel so that the outer panel can be moved between a folded position generally overlapping the inner panel and an unfolded position generally juxtaposed with the inner panel.

2. The notebook divider according to claim 1 further comprising:
a holed edge of the inner panel defining a plurality of notebook apertures for attaching the inner panel onto notebook binders; and
the inner panel and outer panel movable in the folded position along notebook binders between a front-side position and a back-side position.

3. The notebook divider according to claim 2 further comprising:
an inner hinge edge of the inner panel opposite the holed edge; and
the inner hinge edge defining a plurality of inner hinge notches and adjacent inner hinge inserts.

4. The notebook divider according to claim 3 further comprising an outer hinge edge of the outer panel defining a plurality of outer hinge notches and adjacent outer hinge inserts.

5. The notebook divider according to claim 4 wherein the hinge comprises the inner hinge inserts and notches interleaved with the outer hinge inserts and notches.

6. The notebook divider according to claim 5 wherein the inner hinge inserts each have:
a relatively narrow neck extending from the inner hinge edge;
a relatively wide head extending from the neck; and
the neck inserts into an outer hinge notch so that the head is captured by the outer hinge notch.

7. A notebook divider method comprising:
providing an inner panel;
providing an outer panel; and
folding the inner panel onto the outer panel so as to temporarily hide at least a portion of the inner panel and outer panel front sides.

8. The notebook divider method according to claim 7 wherein folding comprises:
interleaving a serrated inner panel edge and a serrated outer panel edge to form a hinge; and
rotating the inner panel about the outer panel.

9. The notebook divider method according to claim 8 wherein interleaving comprises:
defining inserts and corresponding notches along the serrated edges of the inner and outer panels; and
interlocking the serrated edges so as to maintain the integrity of the hinge.

10. The notebook divider method according to claim 9 wherein interlocking comprises:
configuring the inserts with relatively wide insert heads and relatively narrow insert necks;
configuring the notches with relatively wide notch heads and relatively narrow notch necks; and
interleaving inserts on one of the inner and outer panels with notches on the other of the outer and inner panels so that the insert heads are captured by the notch heads.

11. A notebook divider comprising:
an inner panel;
an outer panel; and
a hinge means for interconnecting the inner panel and outer panel so that the inner panel rotates about the outer panel.

12. The notebook divider according to claim 11 wherein the hinge means comprises:
an inner panel serrated edge means for defining an inner panel hinge portion;
an outer panel serrated edge means for defining an outer panel hinge portion; and
the inner panel serrated edge means and the outer panel serrated edge means are interlocked.

13. The notebook divider according to claim 12 wherein:
the inner panel serrated edge means comprises a plurality of inner panel insert means for defining a corresponding plurality of inner panel notch means;
the outer panel serrated edge means comprises a plurality of outer panel insert means for defining a corresponding plurality of outer panel notch means;
the inner panel insert means interleaves with the outer panel notch means; and
the outer panel insert means interleaves with the inner panel notch means.

14. The notebook divider according to claim 13 wherein:
the inner panel insert means inserts into the outer panel notch means; and
the outer panel insert means inserts into the inner panel notch means.
